(19) United States
(12) Patent Application Publication
(10) Pub. No.: US 2006/0110653 A1
(43) Pub. Date: May 25, 2006

(54) Alcohol-air fuel cell

(76) Inventors: Ziya Ramizovich Karichev, Moscow (RU); Mikhail Romanovich Tarasevich, Moscow (RU)

Correspondence Address: LADAS & PARRY, 26 WEST 61ST STREET, NEW YORK, NY, 10023, US

(21) Appl. No.: 10/530,778

(22) PCT Filed: Nov. 18, 2003
(86) PCT No.: PCT/RU03/00500

§ 371 Date: Oct. 12, 2005

(30) Foreign Application Priority Data
Nov. 18, 2002 (RU) 2002130656

(51) Int. Cl. H01M 4/90; H01M 8/10

(52) U.S. Cl. 429/40; 429/30; 429/33; 429/42

(57) ABSTRACT

The invention relates to the field of fuel cells, in particular to alcohol-air fuel cells (AAFC) and may be used during the production of generators on the base of these AAFC. In accordance with the invention AAFC comprises an anode chamber with liquid catalytically active anode, an air chamber with catalytically active gas-diffusion cathode, an electrolyte chamber with a liquid electrolyte and membrane electrolyte, wich is positioned between the cathode and the anode, wherein an aqueous alkaline solution is used as the liquid electrolyte and a non-platinum catalyst, tolerant in respect to alcohole, is used as the cathode catalist. The object of the invention is to create an AAFC that has high efficiency and is inexpensive.

### FIELD OF THE INVENTION

The invention relates to the field of fuel cells, in particular to alcohol-air fuel cells (AAFC) and may be used during the production of generators on the base of these AAFCs.

### BACKGROUND OF THE INVENTION

An AAFC is known that comprises a catalytically active anode and a catalytically active cathode, which are separated by a proton-conducting polymer electrolyte membrane (see patent U.S. Pat. No. 5,599,638, class H 01 M 8/10, 1997).

A drawback of this AAFC is related to the use of a proton-conducting polymer electrolyte membrane, which requires that the humidity of the membrane be maintained within a predetermined narrow range, this limiting the possibility of its use. Wherein the use of complex functional schemes that ensure the maintenance of the predetermined humidity is necessary. Furthermore, the presence of significant diffusion of alcohol through the electrolyte membrane to the cathode reduces the efficacy of operation of the AAFC and reduces its service life because of contamination of the cathode catalyst with alcohol.

Among the known AAFCs the most similar in respect to the combination of material features and achieved technical result is the AAFC comprising an anode chamber with a liquid catalytically active anode, an air chamber with a catalytically active gas-diffusion cathode, an electrolyte chamber with liquid acid and membrane electrolytes (see international application WO 01/39307, class H 01 M 8/00, 2001). A drawback of this AAFC is the use of a corrosive acid electrolyte positioned between the cathode and the anode, which makes the construction of the AAFC more expensive because of the limited choice of structural materials and the necessity to use noble metal catalysts.

### SUMMARY OF THE INVENTION

The object of the invention is to create an AAFC that has high efficacy and is inexpensive.

The indicated technical result is achieved in that in an alcohol-air fuel cell comprising an anode chamber with a liquid catalytically active anode, an air chamber with a catalytically active gas-diffusion cathode, an electrolyte chamber with a liquid electrolyte and a membrane electrolyte, which is positioned between the cathode and the anode, in accordance with the invention an aqueous alkaline solution is used as the liquid electrolyte and a non-platinum catalyst, tolerant in respect to alcohol, is used as the cathode catalyst. The use of an alkaline electrolyte makes it possible to use a more concentrated alcohol-water mixture, which enhances the electrical characteristics of the AAFC, makes the selection of structural materials easier and makes it possible to use catalysts of base metals, which reduces the cost of the AAFC. The use of a non-platinum catalyst, tolerant in respect to alcohol, makes it possible to prevent contamination of the cathode catalyst with diffusing alcohol and associated therewith reduction of the electrical characteristics of the AAFC.

It is advisable that a porous matrix impregnated with an alkaline electrolyte be used as the membrane electrolyte. The use of this matrix makes it possible to limit the diffusion of the alcohol from the anode to the cathode and to prevent a reduction of the characteristics of the AAFC because of self-discharge.

It is advisable that an asbestos matrix be used as the porous matrix. An asbestos matrix is an accessible material that has the required porosity and stability in an alkaline electrolyte.

It is advisable that an anion-exchange membrane be used as the membrane electrolyte. The use of this membrane makes it possible to limit the diffusion of alcohol from the anode to the cathode and prevent a reduction of the specific electrical characteristics of the AAFC because of self-discharge.

It is advisable that a membrane of polybenzimidazole, doped with OH ions, be used as the anion-exchange membrane. This membrane has the required conductivity and diffusion resistance in respect to the transfer of alcohol.

It is advisable that a two-layer gas-diffusion electrode with a hydrophilic barrier layer facing toward the electrolyte chamber and with an active layer facing toward the air chamber be used as the cathode. The presence of a hydrophilic barrier layer makes it possible to use air as the oxidant at increased pressure without flooding the active layer of the cathode.

It is advisable that a two-layer gas-diffusion electrode with a hydrophilic barrier layer facing toward the air chamber and with an active layer facing toward the electrolyte chamber be used as the cathode. The presence of a hydrophilic barrier layer makes it possible to use air as the oxidant at atmospheric pressure without flooding the active layer of the cathode.

It is advisable that the anode consist of an active layer, comprising 3-7 wt. % of fluoroplastic, and a membrane on the base of polybenzimidazole. This makeup of the anode ensures its optimum characteristics.

It is advisable that the anode consist of an active layer, comprising 2-7 wt. % of polybenzimidazole, and a membrane on the base of polybenzimidazole. This makeup of the anode ensures its optimum characteristics.

It is advisable that the anode consist of a porous nickel band, filled with polybenzimidazole, and an active layer comprising 3-7 wt. % of fluoroplastic. This makeup of the anode ensures its optimum characteristics.

It is advisable that the anode consist of a porous nickel band, filled with polybenzimidazole, and an active layer comprising 2-7 wt. % of polybenzimidazole. This makeup of the anode ensures its optimum characteristics.

It is advisable that the anode consist of asbestos, impregnated with polybenzimidazole, and an active layer comprising 3-7 wt. % of fluoroplastic and 2-7 wt. % of polybenzimidazole. This makeup of the anode ensures its optimum characteristics.

It is advisable that a nickel-ruthenium system be used as the anode catalyst. This catalyst as compared with the conventionally used noble metal catalysts is less expensive and has the required electrochemical activity in respect to the alcohol oxidation reaction.

It is advisable that silver on a carbon carrier be used as the non-platinum catalyst on the cathode. This catalyst is tolerant in respect to alcohol and has sufficient activity in respect to the oxygen reduction reaction.

It is advisable that the content of silver on the carrier be 7-18 wt. %. This content of silver on the carrier is optimum for the oxygen reduction reaction.

It is advisable that carbon black or graphite with a specific surface of at least 60-80 m²/g be used as the carbon carrier for the silver catalyst. The use of a carrier with the indicated specific surface makes it possible to ensure the required characteristics of the cathode with a minimum content of silver.

It is advisable that pyropolymers of N₄— complexes on a carbon carrier be used as the non-platinum catalyst. The use of pyropolymers makes it possible to abandon the use of silver and to reduce the cost of the AAFC.

It is advisable that the content of the pyropolymer on the carbon carrier be 10-20 wt. %. This amount of pyropolymer ensures the optimum characteristics of the cathode.

It is advisable that carbon black or graphite with a specific surface of at least 60-80 m²/g be used as the carbon carrier for the pyropolymer catalyst. The use of this carrier makes it possible to reduce the amount of the catalyst used and ensure the required characteristics.

It is advisable that Raney nickel with a ratio Ni:Al equal to 50:50 be used as the anode catalyst of the nickel-ruthenium system. The use of this nickel makes it possible to ensure the required activity of the anode catalyst.

It is advisable that the Renay nickel used in the anode catalyst additionally comprise a molybdenum additive with a ratio Ni:Al:Mo equal to 40:50:10. The addition of molybdenum stabilizes the resource characteristics of the anode catalyst.

It is advisable that the Renay nickel used in the anode catalyst be additionally promoted with platinum.

It is advisable that the Renay nickel with the molybdenum additive, used in the anode catalyst, be additionally promoted with platinum. The addition of platinum significantly increases the activity of the anode catalyst.

It is advisable that the content of platinum and ruthenium in the anode catalyst be 8-15 wt. % with the content of platinum equal to 0.08-0.3 wt. %. This makeup of the anode catalyst ensures the optimum characteristics.

It is advisable that platinum and ruthenium be present in the anode catalyst in the form of crystals of Pt—Ru alloy having a size of 5-7 nm and a specific surface of 45-60 m²/g. These parameters of the catalyst ensure the required characteristics.

It is advisable that the anode have a three-layer structure including a porous base, a layer facing the electrolyte, filled with polybenzimidazole, and an active layer comprising a catalyst and polybenzimidazole. This structure of the anode ensures effective oxidation of the alcohol and the required characteristics.

The essence of the invention is elucidated by the drawing and examples of practical realization of the AAFC.

### DESCRIPTION OF THE DRAWINGS

FIG. 1 shows a section view of an AAFC.

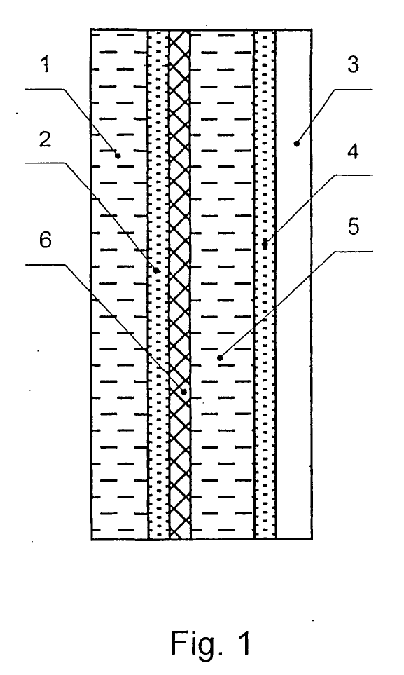

The claimed AAFC comprises an anode chamber 1 with a liquid anode 2 filled with a liquid alcohol-comprising mixture, an air chamber 3 with a gas-diffusion cathode 4. The anode chamber 1 is separated from the air chamber by a liquid alkaline electrolyte 5 and a membrane electrolyte 6 made from a porous membrane impregnated with electrolyte or from an anion-exchange membrane doped with OH ions, for example, polybenzimidazole.

The claimed AAFC may use an alcohol-alkaline mixture or an alcohol-water mixture as the fuel arranged in the anode chamber. The selection of the mixture is determined by the purpose of the AAFC. In the case where it is necessary to obtain higher specific characteristics of the AAFC, it is preferable to use an alcohol-alkaline mixture, since it has greater electrochemical activity. In other variants it is preferable to use an alcohol-water mixture, since the technology of removing the generated carbon dioxide is simpler. Methanol, ethanol, propanol, butanol, ethylene glycol or glycerine may be used as the alcohol. As an example, consideration will be given to the technology of operation of an AAFC wherein a mixture of methanol and an aqueous alkaline solution is used as the fuel. This mixture is fed into the anode chamber 1, an aqueous alkaline solution, for example KOH, is fed into the alkaline chamber, air purified of carbon dioxide and used as an oxidant, is fed into the air chamber 3. When an external load is connected to the anode 2 and cathode 4 of the AAFC, a methanol oxidation reaction will take place on the anode 2 with the generation of free electrons, output to the external load, and the formation of water and carbon dioxide. An air oxygen reduction reaction will take place on the cathode with the formation of OH⁻ ions, which diffuse through the alkaline electrolyte to the anode and participate in the water formation reaction on the anode. The resultant current-forming reaction has the form CH₃OH+3/2O₂=CO₂+2H₂O. In the case where a methanol-alkaline mixture is used as the fuel, the water formed as a result of the current-forming reaction enters the methanol-alkaline mixture, causing its dilution, the carbon dioxide is absorbed by the alkaline with the formation of carbonates. In the case where a methanol-water mixture is used as the fuel, the water formed as a result of the current-forming reaction enters the methanol-water mixture, causing its dilution, the carbon dioxide is removed from the AAFC in the form of a gaseous phase. In order to ensure lengthy operation of the AAFC in the case where the methanol-water mixture is used as the fuel, it is necessary to maintain or the concentration of the fuel in the mixture within a predetermined range, in the case where a methanol-alkaline mixture is used, it is necessary to additionally maintain the concentration of the alkaline and carbonates. Depending on the purpose of the AAFC, the maintenance of the predetermined concentrations is ensured by either the discharge and replacement of the fuel mixture or by adding fuel into the mixture, removing water and carbonates from the mixture, which is provided for by the use of special functional systems.

### EXAMPLES OF PRACTICAL REALIZATION OF AAFC

### Example 1

The cathode has an active layer of a mixture of carbon black AD 100, promoted by a pyropolymer of cobalt tetramethoxyphenyl porphyrin, with a suspension of fluoroplastic in an amount of 20 wt. %, in respect to the dry substance. This mixture of the active mass in an amount of 40 mg/cm² was applied onto the substrate of the cathode by pressing at a pressure of 200 kg/cm² and at a temperature of 300° C. The anode has an active layer of a mixture of 10 wt. % Ni:Mo+Ru/Pt(9:1) and 5 wt. % fluoroplastic. This mixture of the active mass in an amount of 60 mg/cm² was applied to the substrate by the method of pressing at a pressure of 100 kg/cm² with subsequent heating in hydrogen at a temperature of 300° C. A membrane of polybenzimidazole having a thickness of 60 μm and doped in 6 M of KOH was deposited on the anode by an evaporation method. A fuel cell with the indicated anode and cathode in the case where 6 M KOH and 6 M of alcohol are used as the fuel mixture and at a working temperature of 60° C. develop a current density of 120 mA/cm² at a voltage of 0.5 V.

### Example 2

The cathode has an active layer of carbon black AD 100, promoted by 15 wt. % of silver, obtained by reduction of its salt with formaldehyde, and 15 wt. % of fluoroplastic. This mixture of the active mass in an amount of 30 mg/cm² was applied onto the substrate by the method of pressing at a pressure of 200 kg/cm² and at a temperature of 300° C. The anode has an active layer of a mixture of 15 wt. % Ni:Mo+Ru/Pt(9:1) and 4 wt. % polybenzimidazole. This mixture of the active mass in an amount of 80 mg/cm² was applied to the substrate by the method of pressing at a pressure of 100 kg/cm². A membrane of polybenzimidazole having a thickness of 100 μm and doped in 6 M of KOH was applied onto the anode by the method of smearing a 7.5% solution of polybenzimidazole. A fuel cell with the indicated anode and cathode in the case where 6 M KOH and 4 M of alcohol are used as the fuel mixture and at a working temperature of 70° C. develops a current density of 80 mA/cm² at a voltage of 0.5 V.

The conclusion may be made on the basis of the foregoing that the claimed AAFC may be realized in practice with achievement of the claimed technical result.

1. An alcohol-air fuel cell comprising an anode chamber with a liquid catalytically active anode, an air chamber with a catalytically active gas-diffusion cathode, an electrolyte chamber with a liquid electrolyte and a membrane electrolyte, which is positioned between the cathode and the anode, characterized in that an aqueous alkaline solution is used as the liquid electrolyte and a non-platinum catalyst, tolerant in respect to alcohol, is used as the cathode catalyst.

2. The fuel cell according to claim 1, characterized in that a porous matrix impregnated with an alkaline electrolyte is used as the membrane electrolyte.

3. The fuel cell according to claim 2, characterized in that an asbestos matrix is used as the porous matrix.

4. The fuel cell according to claim 1, characterized in that an anion-exchange membrane is used as the membrane electrolyte.

5. The fuel cell according to claim 4, characterized in that a membrane of polybenzimidazole, doped with OH ions, is used as the anion-exchange membrane.

6. The fuel cell according to claim 1, characterized in that a two-layer gas-diffusion electrode with a hydrophilic barrier layer facing toward the electrolyte chamber and with an active layer facing toward the air chamber is used as the cathode.

7. The fuel cell according to claim 1, characterized in that a two-layer gas-diffusion electrode with a hydrophilic barrier layer facing toward the air chamber and with an active layer facing toward the electrolyte chamber is used as the cathode.

8. The fuel cell according to claim 1, characterized in that the anode consists of an active layer, comprising 3-7 wt. % of fluoroplastic, and a membrane on the base of polybenzimidazole.

9. The fuel cell according to claim 1, characterized in that the anode consists of an active layer, comprising 2-7 wt. % of polybenzimidazole, and a membrane on the base of polybenzimidazole.

10. The fuel cell according to claim 1, characterized in that the anode consists of a porous nickel band, filled with polybenzimidazole, and an active layer comprising 3-7 wt. % of fluoroplastic.

11. The fuel cell according to claim 1, characterized in that the anode consists of a porous nickel band, filled with polybenzimidazole, and an active layer comprising 2-7 wt. % of polybenzimidazole.

12. The fuel cell according to claim 1, characterized in that the anode consists of asbestos, impregnated with polybenzimidazole, and an active layer comprising 3-7 wt. % of fluoroplastic and 2-7 wt. % of polybenzimidazole.

13. The fuel cell according to claim 1, characterized in that a nickel-ruthenium system is used as the anode catalyst.

14. The fuel cell according to claim 1, characterized in that silver on a carbon carrier is used as the non-platinum catalyst.

15. The fuel cell according to claim 14, characterized in that the content of silver on the carrier is 7-18 wt. %.

16. The fuel cell according to claim 14, characterized in that carbon black or graphite with a specific surface of at least 60-80 m²/g is used as the carbon carrier for the silver catalyst.

17. The fuel cell according to claim 1, characterized in that pyropolymers of N₄-complexes on a carbon carrier are used as the non-platinum catalyst.

18. The fuel cell according to claim 17, characterized in that the content of the pyropolymer on the carbon carrier is 10-20 wt. %.

19. The fuel cell according to claim 17, characterized in that carbon black or graphite with a specific surface of at least 60-80 m²/g is used as the carbon carrier for the pyropolymer catalyst.

20. The fuel cell according to claim 13, characterized in that Raney nickel with a ratio Ni:Al equal to 50:50 is used as the anode catalyst of the nickel-ruthenium system.

21. The fuel cell according to claim 20, characterized in that the Renay nickel used in the anode catalyst additionally comprises a molybdenum additive with a ratio Ni:Al:Mo equal to 40:50:10.

22. The fuel cell according to claim 20, characterized in that the Renay nickel used in the anode catalyst is additionally promoted with platinum.

23. The fuel cell according to claim 21, characterized in that the Renay nickel with the molybdenum additive, used in the anode catalyst, is additionally promoted with platinum.

24. The fuel cell according to claim 22, characterized in that the content of platinum and ruthenium in the anode catalyst is 8-15 wt. % with the content of platinum equal to 0.08-0.3 wt. %.

25. The fuel cell according to claim 22, characterized in that platinum and ruthenium are present in the anode catalyst in the form of crystals of Pt—Ru alloy having a size of 5-7 nm and a specific surface of 45-60 m²/g.

26. The fuel cell according to claim 13, characterized in that the anode has a three-layer structure including a porous base, a layer facing the electrolyte, filled with polybenzimidazole, and an active layer comprising a catalyst and polybenzimidazole.
